(19) United States
(12) Patent Application Publication
(10) Pub. No.: US 2008/0147510 A1
(43) Pub. Date: Jun. 19, 2008

(54) Method and System for Managing Digital Content Stored in an Electronic Device

(75) Inventors: Michael R. Wimberly, Sammamish, WA (US); Jeffrey D. Ollis, Dresher, PA (US); Richard D. Snelson, Redmond, WA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/612,292

(22) Filed: Dec. 18, 2006

(51) Int. Cl. G06Q 20/00

(52) U.S. Cl. 705/18

(57) ABSTRACT

The present invention provides a method for managing a digital content stored in an electronic device (102). The electronic device is capable of storing and retrieving the digital content. The method includes storing (304) a plurality of user profiles at the electronic device. Each user profile of the plurality of user profiles includes pre-defined digital content preferences. Further, the method includes accessing (306) at least one user profile of the plurality of user profiles in response to a user identification parameter. Further, the method includes managing (308) the stored digital content for the at least one accessed user profile.

The present invention generally relates to field of electronic devices. More specifically, it relates to electronic devices capable of storing and retrieving a digital content.

### BACKGROUND OF THE INVENTION

Electronic devices can be used to broadcast and store the digital content. A Digital Television (DTV) set is an example of such an electronic device that can be used to broadcast digital content. The DTV set uses digital signals transmitted from a transmission network for displaying the digital content. The digital content received at the DTV set is restricted to specific channel frequencies. The digital content thus received can then be displayed at the DTV set.

A digital video recording (DVR) device is another electronic device and can be used to store the digital content. Examples of electronic device that can store the digital content include Personal Video Recorders (PVRs) and DVR devices. Further, the DVR can be programmed to record the digital content that is received at the DTV set at a particular channel frequency and a particular time. The digital content is stored in a memory at the DVR. The memory can either be a separate device or integrated with the DVR. The digital content that is stored in the storage device can be viewed by the user of the DVR at a later time. The digital content stored in the storage device can be viewed a multiple number of times, based on individual user preferences.

Typically, the electronic devices, like the DTVs and the DVRs, have one or more of the following limitations. Firstly, there is no system for managing the stored digital content available to users of the electronic devices. There are no provisions to restrict certain users from accessing sensitive stored digital content. For example there are no provisions for parents to restrict the viewing on a DVR of a violent movie that is not deemed appropriate for their children. Secondly, there is no system and method to review an amount and a type of the stored digital content being accessed by the users of the electronic devices. For example, there are no provisions for the parents to review a length of time for which the digital content was viewed and a genre of the digital content viewed, such as sports, animation, spiritual, and the like. Thirdly, the electronic devices are not capable of reducing the amount of information about the stored digital content that is being displayed at the electronic device. The information about the stored digital content can be a pictorial image that represents each of the digital content, a title of each of the digital content, a time of last access of each the digital content and the like. Displaying information about all the stored digital content that may be not of interest to a particular user may lead to display of unnecessary and useless information on a display screen. Fourthly, the stored digital content may be accidentally deleted by a user of the electronic device before other users of the electronic devices have viewed the stored digital content.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an electronic device and a Digital Television (DTV), where various embodiments of the present invention can be practiced;

FIG. 2 illustrates an electronic device for managing a digital content stored in an electronic device, in accordance with various embodiments of the present invention;

FIG. 3 is a flow diagram illustrating a method for managing a digital content stored in an electronic device, in accordance with various embodiments of the present invention; and

FIG. 4 is a flow diagram illustrating a method for managing a digital content stored in an electronic device, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help to improve an understanding of embodiments of the present invention.

### DETAILED DESCRIPTION

Before describing in detail the particular system and system for managing a digital content stored in an electronic device, in accordance with various embodiments of the present invention, it should be observed that the present invention resides primarily in combinations of method steps related to method for managing digital content in the electronic device. Accordingly, the system components and method steps have been represented, where appropriate, by conventional symbols in the drawings, showing only those specific details that are pertinent for an understanding of the present invention, so as not to obscure the disclosure with details that will be readily apparent to those of ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

The present invention provides a method for managing a digital content stored in an electronic device. The electronic device is capable of storing and retrieving the digital content. The method includes storing a plurality of user profiles at the electronic device. Each user profile of the plurality of user profiles includes pre-defined digital content preferences. Further, the method includes accessing at least one user profile of the plurality of user profiles in response to a user identification parameter. Further, the method includes managing the stored digital content for the at least one accessed user profile.

Various embodiments of the present invention provide an electronic device capable of managing a digital content. The electronic device is capable of storing and retrieving the digital content. The electronic device includes an interface for receiving a user identification parameter. Further, the electronic device includes a memory adapted for storing at least a) digital content and b) a plurality of user profiles. Each user profile of the plurality of user profiles includes pre-defined digital content preferences. Further, the electronic device includes a processor adapted to selectively access at least one user profile of the plurality of user profiles in response to the user identification parameter received. The processor is also adapted to manage the stored digital content for the at least one accessed user profile.

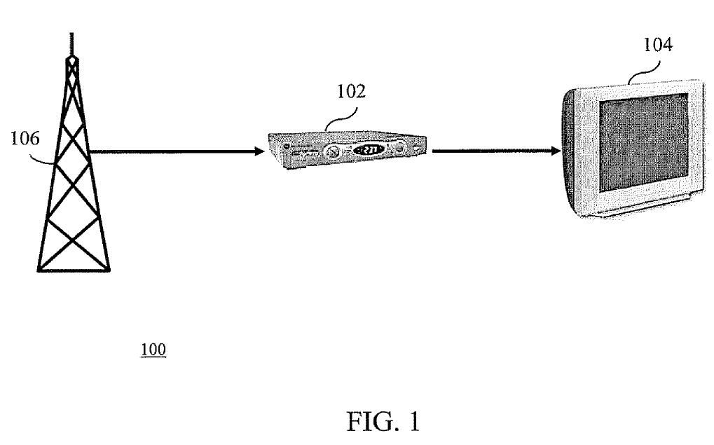

FIG. 1 illustrates an electronic device 102 and a Digital Television (DTV) set 104, where various embodiments of the present invention can be practiced. Further, FIG. 1 shows a broadcasting station 106. The broadcasting station 106 broadcasts signals of a digital content in a particular geographical area. The signals for the digital content represent data for the digital content, including audio and video programs, Internet WebPages, interactive games, and the like. The signals carry digital content by variations in voltage, frequency, amplitude, and location of the signals. The broadcasting station 106 can broadcast the signals for the digital content through several channel frequencies at same time. Examples of the broadcasting station 106 include, but are not limited to, a transmission tower, a digital cable Television (TV) station, a communications satellite, a satellite dish antenna, and the like. The signals broadcast by the broadcasting station 106 can be received at the electronic device 102. The electronic device 102 converts the signals received into the digital content for display on the DTV set 104. For example, the electronic device 102 can receive the signals in an encoded format and decodes them into a format that can be displayed on a television screen or the DTV set 104. The electronic device 102 may also include functionalities to record the digital content on a storage device or a memory. Further, the electronic device 102 may include one or more softwares to enable the digital content to be recorded on the storage device or the memory. The stored digital content can be retrieved from the electronic device 102 and played again at the DTV set 104 at a later time. The digital content stored in the electronic device 102 can be displayed on the DTV set 104. The DTV set 104 also includes a display screen to display the stored digital content.

For an embodiment of the present invention, the electronic device 102 can be integrated with the DTV set 104. In such an embodiment, the DTV set 104 can perform the functionalities of the electronic device 102.

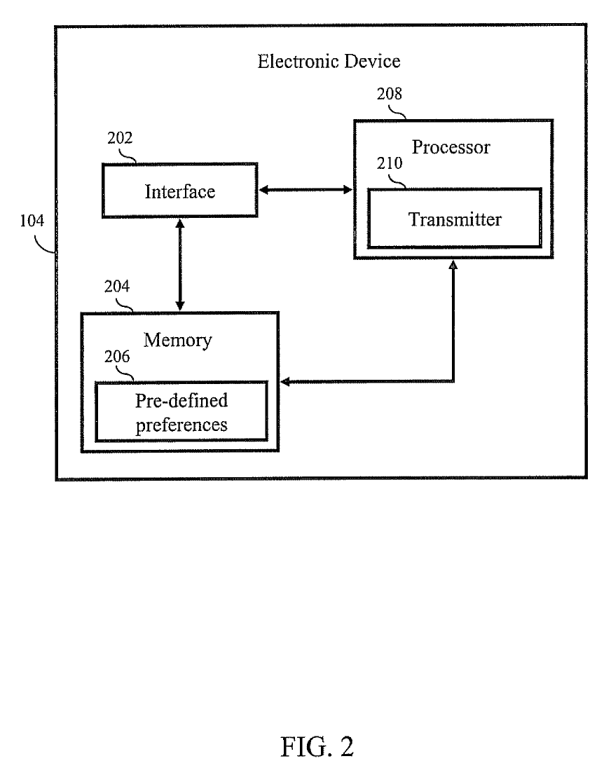

Nowadays, users can create unique profiles for accessing a desktop computer. The multiple users use the desktop computer by using their unique user profiles. A user profile includes a user's personalized information like desktop settings and personal setup preferences. The personalized information is retained in the desktop computer for the one or more users to access each time they use the desktop computer. This enables multiple users to use a single desktop computer without compromising on their privacy. According to the present invention, user profiles can be created at the electronic device 102. The user profiles can be used for managing the digital content stored at the electronic device 102. A system for managing the stored digital content by creation of user profiles is further explained in conjunction with FIG. 2.

FIG. 2 illustrates the electronic device 102 for managing a digital content stored at the electronic device 102, in accordance with various embodiments of the present invention. The electronic device 102 includes an interface 202. The interface 202 can receive a user identification parameter from a user of the electronic device 102. The interface 202 can communicate the user identification parameter to the electronic device 102. Examples of the interface 202 can include a user interface, such as graphic means for the user to communicate with the electronic device 102, or an input mechanism, such as a physical means of communication like a touchpad keyboard. Further, the electronic device 102 includes a memory 204. The memory 204 is adapted to store the digital content. The memory 204 is also adapted to store a plurality of user profiles. Each user profile of the plurality of user profiles includes pre-defined digital content preferences 206. The pre-defined digital content preferences 206 stored in the memory 204 may include a list of allowed stored digital content, a list of disallowed stored digital content, a stored digital content check-list, and the like. The memory 204 can also store a particular menu of commands, a particular digital content, and a particular content listing for each user profile of the plurality of user profiles. Examples of the memory 204 include a flash random access memory (RAM), an optical disk, a magnetic storage device, a floppy disk drive, a hard disk drive, and the like.

Further, the electronic device 102 includes a processor 208. The processor 208 is adapted to selectively access at least one user profile of the plurality of user profiles. The processor 208 also manages the stored digital content for the at least one accessed user profile. Furthermore, the electronic device 102 also includes a transmitter 210. The transmitter 210 is integrated with the processor 208. The transmitter 210 can transmit a digital signal that identifies the stored digital content. The digital signal is transmitted to the DTV set 104. For an embodiment of the present invention, the transmitter 210 in the electronic device 102 may be separated from the processor 208.

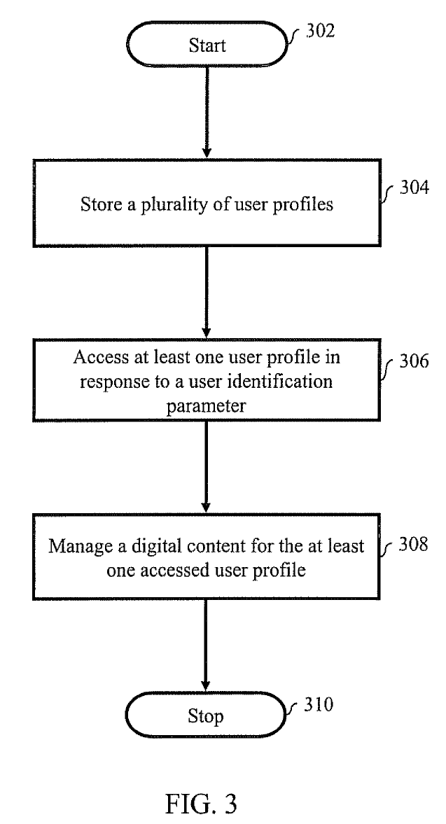

FIG. 3 is a flow diagram illustrating a method for managing a digital content stored in the electronic device 102, in accordance with various embodiments of the present invention. The method explains, in brief, the important steps required to practice the present invention. The method is initiated at step 302. At step 304, a plurality of user profiles is stored at the electronic device 102. Each user profile of the plurality of user profiles includes the pre-defined digital content preferences 206. For an embodiment of the present invention, the pre-defined digital content preferences 206 can be stored in the memory 204. At step 306, at least one user profile of the plurality of user profiles is selectively accessed. The at least one user profile is selectively accessed in response to a user identification parameter. The user identification parameter can be received at the interface 202. For an embodiment, the processor 208 can be adapted to selectively access the at least one user profile. Further, at step 308, the digital content is managed for the at least one accessed user profile. The digital content is stored at the electronic device 102. The stored digital content is managed based on the pre-defined digital content preferences 206. For an embodiment of the present invention, the processor 208 can be adapted to manage the stored digital content. Thereafter, the method is terminated at step 310.

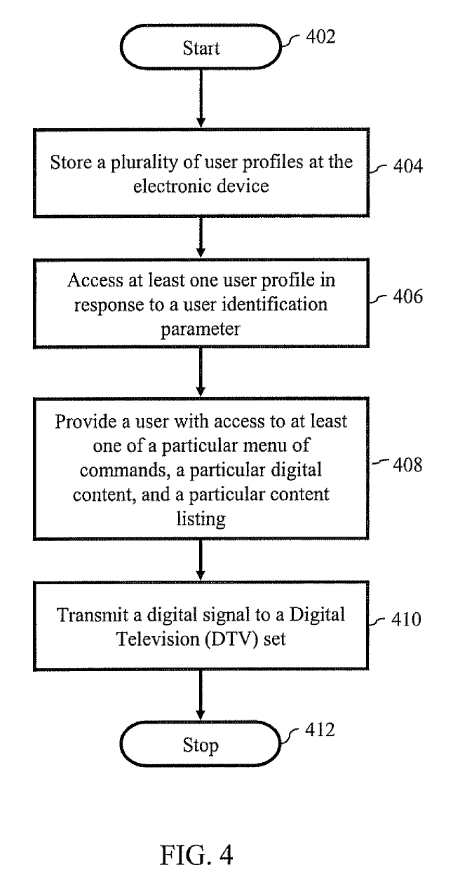

FIG. 4 is a flow diagram illustrating a method for managing a digital content stored at the electronic device 102, in accordance with an embodiment of the present invention. The method explains, in detail, the steps required to practice the present invention. The method is initiated at step 402. At step 404, a plurality of user profiles is stored at the electronic device 102. Each user profile of the plurality of user profiles includes the pre-defined digital content preferences 206.

For an embodiment of the present invention, the plurality of user profiles can include at least one administrator profile and a plurality of user profiles. Each user of the electronic device 102 can have one or more user profiles associated. Further, a few users of the electronic device 102 can have an administrator profile associated. The administrator profile can manage the stored digital content accessible for each user profile of the plurality of user profiles. For example, the present invention can be practiced on a TV set in a household. The TV set can also include a digital video recording (DVR) device. Users of the TV set in the household may include a father, a mother, a son and a daughter. Each user in the household can be assigned one or more user profiles. Each user can use the associated user profiles to access the stored digital content. The father can also have an administrator profile. The father can use his administrator profile to manage the stored digital content accessible for each user profile of the users of the TV set. Additionally, the mother can also have an administrator profile to manage the stored digital content accessible for each user profile. For an embodiment, the interface 202 can receive the request to create the plurality of profiles from the user of the electronic device 102.

The pre-defined digital content preferences 206 for each user profile can include at least one of a list of allowed stored digital content, a list of disallowed stored digital content, and a stored digital content check-list. The list of allowed stored digital content for a user profile includes details of the digital content stored at the electronic device 102 that is allowed for access in the user profile. The list of disallowed stored digital content for a user profile includes details of the digital content stored at the electronic device 102 that is not allowed for access in the user profile. A user can use an administrator profile to define the pre-defined digital content preferences 206 for the plurality of user profiles. For example, in the example mentioned above, the father can use his administrator profile to assign the pre-defined digital content preferences 206 for the user profile of the son. The father can define the list of allowed stored digital content for the user profile of the son to allow the stored digital content like a cartoon program to be accessed and disallow the stored digital content like horror movies to be accessed.

The stored digital content check-list includes details of the digital content that is stored in the electronic device 102. The stored digital content check-list provides the user of the each profile an option to check mark each one of the digital content stored in the electronic device 102. The user of the each profile can check mark each one of the stored digital content to indicate that the stored digital content has been accessed by him/her. The user can also check mark to indicate that the stored digital content may now be deleted from the electronic device 102. The method described in accordance with various embodiments, helps to determine whether all users who have access to and interest in a first particular stored digital content have accessed the first particular stored digital content. A user of an administrator can then decide when the first particular stored digital content can be deleted from the electronic device 102. Thus, deletion of the stored digital content can be prevented prior to access by all interested users. For an embodiment of the present invention, the pre-defined digital content preferences 206 can be stored in the memory 204.

At step 406, at least one user profile of the plurality of user profiles is selectively accessed. The at least one user profile is selectively accessed in response to a user identification parameter. The user identification parameter can be used to verify the identity of the users and allow only the intended user of the at least one user profile to access the at least one user profile. For an embodiment of the present invention, the processor 208 can be adapted to selectively access the at least one user profile in response to the user identification parameter. The user identification parameter can be a password. Examples of the password include, but are not limited to, a set of alphanumeric characters, a Personal Identification Number (PIN) and the like. The user identification parameter can also be a biometric parameter. Examples of the password include, but are not limited to, physical characteristics like fingerprints, retinal patterns, and hand measurements and behavioral characteristics like signatures and typing patterns. For an embodiment of the present invention, the user identification parameter can be received at the interface 202. For example, in the example mentioned above, the user profile of the son can be assigned the user identification parameter in form of a password. For example, when the son correctly inputs the password at the interface 202, the processor 208 selectively accesses the user profile of the son that is stored at the electronic device 102. Further, the father can use his administrator profile to define the user identification parameter for each user profile, including the user profile of the son.

At step 408, the user of the at least one accessed user profile is provided with access to at least one of a particular menu of commands, a particular digital content, and a particular content listing. The particular menu of commands is a list of options and commands displayed on a display screen. The user can select a specific command from the particular menu of commands to access the particular digital content. The examples of the particular menu of commands include, but are not limited to, a set of choices displayed in a tabular format, a drop-down menu, a shortcut menu, and the like. For an embodiment of the present invention, the processor 208 can be adapted to provide the user with the access. For example, in the example mentioned above, when the son correctly inputs the password at the interface 202, the processor 208 selectively accesses the user profile of the son and provides him with access to the particular menu of commands. The son selects a command from the particular menu of commands to access a cartoon program. The processor 208 then provides the son with access to the cartoon program.

The particular content listing includes details of the stored digital content that is displayed in the at least one accessed user profile. For example, in the example mentioned above, the particular content listing will include details of the digital content that is accessed by the son in his user profile. The particular content listing can include details like the length of time for which the particular digital content was displayed and a start time and an end time for which the particular digital content was displayed. The particular content listing may also include a particular digital content name and a type of the particular digital content displayed. The type of the particular digital content can include details like a genre of the particular digital content, such as sports, animation, spiritual, and the like, and a viewer suitability rating of the particular digital content, such a sensitivity rating for children, teenagers, and adults. The particular content listing can help the user of the administrator profile to review the duration time and the type of digital content displayed in the at least one user profile. For example, the father can review the length of time, the start and the end time, and the genre of the digital content accessed in the son's user profile. Based on the review, the father can modify the pre-defined digital content preferences for the user profile of the son.

At step 410, a digital signal identifying the particular digital content is transmitted to the DTV set 104. For example, after the son is provided with access to the cartoon program, the digital signal identifying the cartoon program is transmitted to the DTV set 104. The DTV set 104 can display the particular digital content on a display screen. The son can access the particular digital content on the display screen. For an embodiment of the present invention, the transmitter 210 can transmit the digital signal to the DTV set 106. For an embodiment of the present invention, a display screen can be integrated with the electronic device 102. The particular digital content can be displayed at the display screen integrated with the electronic device 102. Thereafter, the method is terminated at step 412.

For another embodiment, the present invention can be applied on a TV set in a hostel. The TV set can also include a digital video recording (DVR) device. Users of the TV in the hostel include a Warden, a Junior Student, a Senior Student, and a PhD Scholar. Each user in the hostel can be assigned one or more user profiles associated. The each user can use an associated user profile to access the digital content on the TV set. The Warden can also have an administrator profile. The Warden can use the administrator profile to manage the stored digital content accessible in the user profiles of the users of the TV. The Warden uses his administrator profile to define the predefined digital content preferences for the user profiles of the Junior Student, the Senior Student, and the PhD Scholar. The Warden can define the predefined digital content preferences to allow the Junior Student to access stored digital content like cartoon programs but disallow access to stored digital content like a Soccer match. Similarly the Warden can define the predefined digital content preferences to allow the PhD Scholar to access stored digital content like news programs but disallow the PhD Scholar to access stored digital content like movies. To access his user profile, the Junior Student is assigned a password. The Junior Student inputs his password into the electronic device 102. The electronic device 102 provides the Junior Student with access to the stored digital content allowed in his user profile. When the Junior Student opts to watch the stored cartoon program, such as The Popeye Show, the electronic device 102 sends a digital signal identifying the digital content corresponding to the cartoon program to the DTV set 104. The DTV set 104 then displays the cartoon program on a display screen for the Junior student to watch.

Various embodiments of the present invention offer one or more advantages. The present invention provides a system and method to restrict sensitive users from accessing certain types of the digital content, depending on individual user preferences. Further, the present invention provides a system and method to review an amount and a type of the digital content accessed by users of the electronic device. Further, the present invention provides a system and method to reduce the amount of information about the digital content displayed at the electronic device. This reduces display of unnecessary and useless information on the display screen as only that information about the digital content is displayed on a display screen that is of interest to a particular user. Furthermore, the present invention provides a system and method to prevent accidental deletion of the digital content. The digital content cannot get deleted before viewing by all interested users of the electronic device.

It will be appreciated that the method and system for managing the digital content in the electronic device described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method to enable users to view a broadcasted media stream differently. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one of ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one of ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for managing a digital content stored in an electronic device, the electronic device being capable of storing and retrieving the digital content, the method comprising:
storing a plurality of user profiles at the electronic device, each user profile of the plurality of user profiles comprising pre-defined digital content preferences;
accessing at least one user profile of the plurality of user profiles in response to a user identification parameter; and
managing the digital content for the at least one accessed user profile, the digital content being stored in the electronic device.

2. The method as recited in claim 1, wherein managing the digital content for the at least one accessed user profile comprises:
providing a user with access to at least one of a particular menu of commands, a particular digital content, and a particular content listing.

3. The method as recited in claim 2, wherein the particular content listing comprises at least one of a duration time of a particular digital content displayed and a type of the particular digital content displayed.

4. The method as recited in claim 1, wherein managing the digital content for the at least one accessed user profile further comprises:
transmitting a digital signal to a Digital Television (DTV) set, wherein the digital signal is identifying a particular digital content.

5. The method as recited in claim 1, wherein managing the digital content for the at least one user profile further comprises:
displaying a particular digital content at the electronic device.

6. The method as recited in claim 1, wherein the plurality of user profiles comprises at least one administrator profile and the plurality of user profiles.

7. The method as recited in claim 1, wherein the user identification parameter comprises a password.

8. The method as recited in claim 1, wherein the user identification parameter comprises a biometric parameter.

9. An electronic device for storing and retrieving digital content, the electronic device comprising:
an interface for receiving a user identification parameter;
a memory adapted for storing at least a) digital content and b) a plurality of user profiles, wherein each user profile of the plurality of user profiles comprises pre-defined content preferences; and
a processor adapted to:
selectively access at least one user profile of the plurality of user profiles in response to the user identification parameter received; and
manage the digital content for the at least one accessed user profile, the digital content being stored in the memory.

10. The electronic device as recited in claim 9, wherein managing the digital content for the at least one accesses user profile comprises:
providing a user with access to at least one of a particular menu of commands, a particular digital content, and a particular content listing.

11. The electronic device as recited in claim 10, wherein the content listing comprises at least one of a duration time of a particular digital content displayed and a type of the particular digital content displayed.

12. The electronic device as recited in claim 9, wherein managing the digital content for the at least one accessed user profile further comprises:
transmitting a digital signal identifying a particular digital content to a Digital Television (DTV) set.

13. The electronic device as recited in claim 9, wherein managing the digital content for the at least one accessed user profile further comprises:
displaying a particular digital content at the electronic device.

14. The electronic device as recited in claim 9, wherein the plurality of user profiles comprises at least one administrator profile and the plurality of user profiles.

15. The electronic device as recited in claim 9, wherein the user identification parameter comprises a password.

16. The electronic device as recited in claim 9, wherein the user identification parameter comprises a biometric parameter.
